(19) United States
(12) Patent Application Publication
(10) Pub. No.: US 2002/0000963 A1
(43) Pub. Date: Jan. 3, 2002

(54) Liquid crystal display device, and electronic device and mobile communication terminal comprising the display device

(76) Inventors: Hironori Yoshida, Sagamihara-shi (JP); Masayuki Sakanishi, Hachioji-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/855,507

(22) Filed: May 16, 2001

(30) Foreign Application Priority Data
Jun. 29, 2000 (JP) 2000-196318

(51) Int. Cl. G09G 3/36

(52) U.S. Cl. 345/87

(57) ABSTRACT

A mobile terminal comprises a circuit for selectively setting one of two DUTY values, in a display timing generation circuit of a display drive circuit. A memory section includes a region information table storing a region including a position of the terminal, a commercial power frequency used in the region, and a command which is set in correspondence with the commercial power frequency. The stored region, commercial power frequency and set command correspond to position information of the terminal. The position information is acquired from a plurality of peripheral base stations to calculate the position of the terminal, when the terminal user performs resetting operations and the position registration procedures. The set command is read from the region information table in accordance with the position thus calculated. The set command is supplied to the display timing generation circuit, whereby one of two DUTY values is selected.

### CROSS-REFERENCE TO RELATED APPLICATIONS

This application is based upon and claims the benefit of priority from the prior Japanese Patent Application No. 2000-196318, filed Jun. 29, 2000, the entire contents of which are incorporated herein by reference.

### BACKGROUND OF THE INVENTION

This invention relates to a liquid crystal display device, an electronic device comprising the liquid-crystal display, such as a notebook-sized personal computer, an audio player or the like, and a mobile communication terminal comprising the liquid-crystal display, such as a mobile telephone, PDA (Personal Digital Assistants) or the like.

Generally, a small electronic device and a mobile communication terminal, such as a notebook-sized personal computer, a mobile telephone and the like, have a display that comprises a thin LCD (Liquid Crystal Display) panel of small power consumption. To display data on the LCD panel, the data is stored into the display RAM which is provided in a display drive circuit. A timing generation circuit generates a display drive signal that corresponds to a display frame frequency. The data is supplied to the LCD panel in synchronization with the display drive signal.

The clock frequency of the display drive signal is set for each device, in accordance with a desired display-response speed and the power consumption. Inevitably, flicker may occur on the display in some regions where the LCD display is used. Flicker occurs when the LCD display is placed under a fluorescent lamp. In view of this the flicker seems to result from the mutual interference between the clock frequency and the power frequency commercially available in such regions. It is demanded that this problem be solved.

### BRIEF SUMMARY OF THE INVENTION

An object of the present invention is to provide a liquid crystal display device that can reliably prevent flicker on display, in whichever region the device is used, thereby improving the display quality. Another object of the invention is to provide an electronic device and mobile communication terminal, each comprising the liquid crystal display device.

To achieve the objects, a liquid crystal display device according to the invention, an electronic device and a mobile communication terminal, each comprising the liquid crystal display device, comprise: a signal generating section for generating a plurality of display drive signals; a frequency recognizing section for recognizing a commercial power frequency of a region where the device is used; and a frequency control section. The display drive signals generated by the signal generating section have different frequencies. The frequency control section can change the frequency of each display drive signal generated by the signal generating section, in accordance with the commercial power frequency recognized by the recognizing section.

According to the present invention, the commercial power frequency used in each region is determined. In accordance with the commercial power frequency, the clock frequency of the display drive signal is changed to a value that does not interfere with the commercial power frequency. Thus, even if the liquid crystal display device or the electronic device comprising the liquid crystal display device were used in any country or region, the clock frequency would not interfere with the power frequency of indoor fluorescent lamps. The liquid crystal display device can always display high-quality images.

The present invention is also characterized in that a geographic information acquainting section may be used in place of the recognizing section. In this case, the geographic information acquiring section acquires the geographic information representing the current position of the device or terminal. From the geographic information the electronic device determines a frequency the display drive signal must have in the place where the electronic device is located. The display drive signal generating section can therefore generate a display drive signal that has the frequency thus determined.

Even in this structure, the display drive signal frequency for each region is variably controlled at a value that causes no flicker. For this reason, even if the liquid crystal display device or the electronic device comprising the liquid crystal display device is brought and used in any country or region, the interference with the indoor fluorescent lamp is avoided and thereby the high-quality display can be always implemented.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram of a mobile communication terminal comprising an LCD display device according to the first embodiment of the present invention;

FIG. 2 is a block diagram of the LCD display device provided in the mobile communication terminal of FIG. 1;

FIG. 3 shows a region information table;

FIG. 4 is a flowchart explaining the process of changing the frequency of the display drive signal by means of the control section incorporated in the mobile communication terminal of FIG. 1;

FIG. 5 is a flowchart of a mobile communication terminal comprising an LCD display device according to the second embodiment of the invention; and

FIG. 6 is a block diagram of a mobile communication terminal comprising an LCD display device according to the third embodiment of the invention.

### DETAILED DESCRIPTION OF THE INVENTION

(First Embodiment)

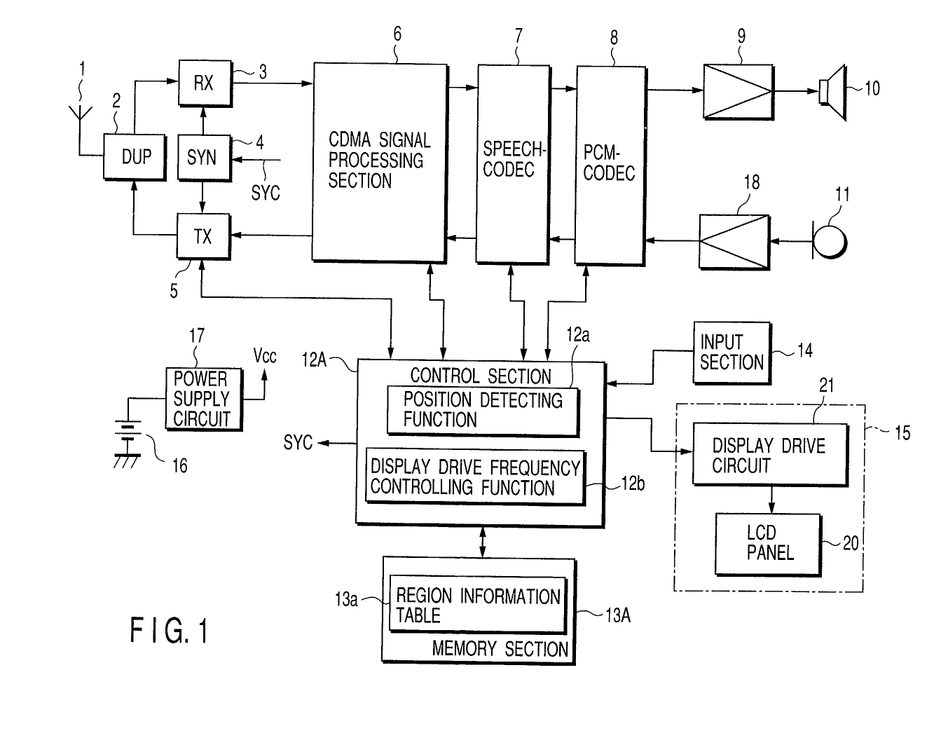

FIG. 1 shows a block diagram of a CDMA mobile communication terminal that comprises an LCD display device according to the first embodiment of the present invention.

An antenna 1 receives a RF signal from a base station (not shown). The RF signal is input to a receiver circuit (RX) 3 through a duplexer (DUP) 2. The receiver circuit 3 mixes the RF signal with a reception local oscillation signal supplied from a frequency synthesizer (SYN) 4. The RF signal is thereby down-converted, into a reception IF signal. The reception local oscillation signal generated from the frequency synthesizer 4 has the frequency designated by a control signal SYC supplied from a control section 12A.

The reception IF signal is input to a CDMA signal processing section 6. The CDMA signal processing section 6 de-spreads the reception IF signal by using a spread code that is assigned to a reception channel. Next, the section 6 performs quadrature demodulation on the reception IF signal. Demodulated data of a specific format corresponding to a data rate is thereby generated. The demodulated data is input to a speech-encoder/decoder (hereinafter speech-codec) 7. Meanwhile, a signal representing the data rate of the demodulated data is input to the control section 12A.

The speech-codec 7 expands the demodulated data output from the CDMA signal processing section 6, on the basis of the reception data rate represented by a signal supplied from the control section 12A. Next, the speech-codec 7 corrects and decodes the expanded demodulation data, or effects speech decoding and Viterbi decoding or the like. Base-band data is thereby generated.

A PCM-encoder/decoder (hereinafter PCM-codec) 8 is provided, which performs one of two decoding processes in accordance with which communication type is designated by the control section 12A, speech communication or data communication. To achieve the speech communication, the PCM-docec 8 effects PCM-decoding on the base-band data output from the speech-codec 7, converting the base-band data into an analog reception signal. The analog reception signal is amplified at a reception amplifier 9 and output from a loudspeaker 10. To accomplish the data communication, the base-band data is input to the control section 12A. The section 12A stores the base-band data into a memory section 13A. The base-band data is output to a PDA or a personal computer through an external interface (not shown) in accordance with a user's request.

A transmission amplifier 18 receives a speech signal representing a speech and input to a microphone 11 during the speech communication. The amplifier 18 amplifies the speech signal to a proper level a, which is supplied to the PCM-codec 8. The PCM-codec 8 carries out PCM-coding/decoding on the speech signal. The speech signal subjected to the PCM-coding/decoding is input to the speech-codec 7. Transmission data output from a PDA or a notebook-sized personal computer (not shown), or the image data generated by a camera (not shown) is input to the control section 12A through the external interface.

During the speech communication, the speech-codec 7 detects the energy of the input speech, from the transmission speech data output from the PCM-codec 8. From the energy detected, the speech-codec 7 determines the data rate. The speech-codec 7 then compresses the transmission speech data, generating a compressed burst signal of the format corresponding to the data rate. The speech-codec 7 executes error correction and encoding on the compressed burst signal and generates an encoded signal, i.e. encoded data. The encoded data is output to the CDMA signal processing section 6.

During the data transmission, the speech-codec 7 compresses the transmission data passing through the PCM-codec 8, generating a compressed burst signal of the format corresponding to a preset data rate. The speech-codec 7 performs error correction and encoding on the compressed burst signal and generates an encoded signal, i.e. encoded data. The encoded data is output to the CDMA signal processing section 6. The data representing the data rate for the speech communication and the data rate for the data communication is supplied to the control section 12A.

The CDMA signal processing section 6 receives the encoded data from the speech-codec 7 and modulates the data in a digital modulation scheme such as QPSK. A transmission signal digitally modulated is thereby generated. The section 6 spreads the transmission signal by using the spread code assigned to the transmission channel, and outputs the transmission signal to a transmitter circuit (TX) 5.

The transmitter circuit 5 synthesizes the transmission signal with the transmission local oscillation signal generated by the frequency synthesizer 4, generating an RF signal. The circuit 5 amplifies the effective portion of the RF signal on the basis of the transmission data rate supplied from the control section 12A, thus generating a transmission RF signal. The transmission RF signal is supplied to the antenna 1 through the duplexer 2 and transmitted to a base station (not shown).

The CDMA mobile communication terminal comprises an input section 14, a battery 16, and a power supply circuit 17. The input section 14 has a key group including a dial key, a transmission key, a power supply key, a terminate key, a volume control key, a mode selection key, and the like. The power supply circuit 17 generates a predetermined power-supply voltage Vcc from the output of a battery 16. The power-supply voltage Vcc is applied to and supplies the voltage to the various circuit sections incorporated in the CDMA mobile communication terminal.

The mobile communication terminal has an LCD display device 15 used as a display unit. The LCD display device 15 comprises an LCD panel 20 and a display drive circuit 21.

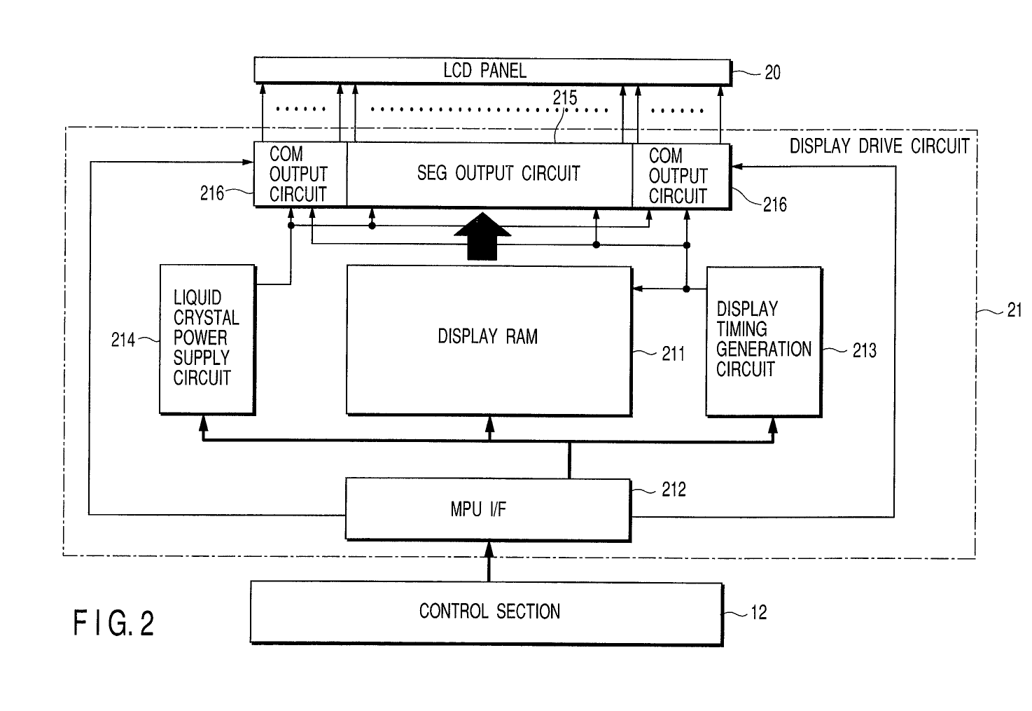

As shown in FIG. 2, the display drive circuit 21 comprises a display RAM 211, an MPU interface (MPUI/F) 212, a display timing generation circuit 213, a liquid crystal power supply circuit 214, an SEG output circuit 215 and a COM output circuit 216.

The MPUI/F 212 receives display data and a control signal from a microprocessor (MPU) of the control section 12A and supplies them to the display RAM 211, the display timing generation circuit 213 and the liquid crystal power supply circuit 214. The display RAM 211 expands the display data transmitted from the control section 12A through the MPUI/F 212. The SEG output circuit 215 and the COM output circuits 216 generate column data and row data from the display data output from the display RAM 211. The column data and the row data are supplied to the LCD panel 20.

The display timing generation circuit 213 generates one of two display clocks different in frequency to operate the display RAM 211, SEG output circuit 215 and COM output circuits 216. The frequency of each display clock has such a value to render the display flicker not noticeable when the frequency is the commercial power frequency of 50 or 60 Hz. The display timing generation circuit 213 has a circuit for generating DUTY values to generate two display clock frequencies. The DUTY value is changed in accordance with a set command generated by the control section 12A, which will be described later.

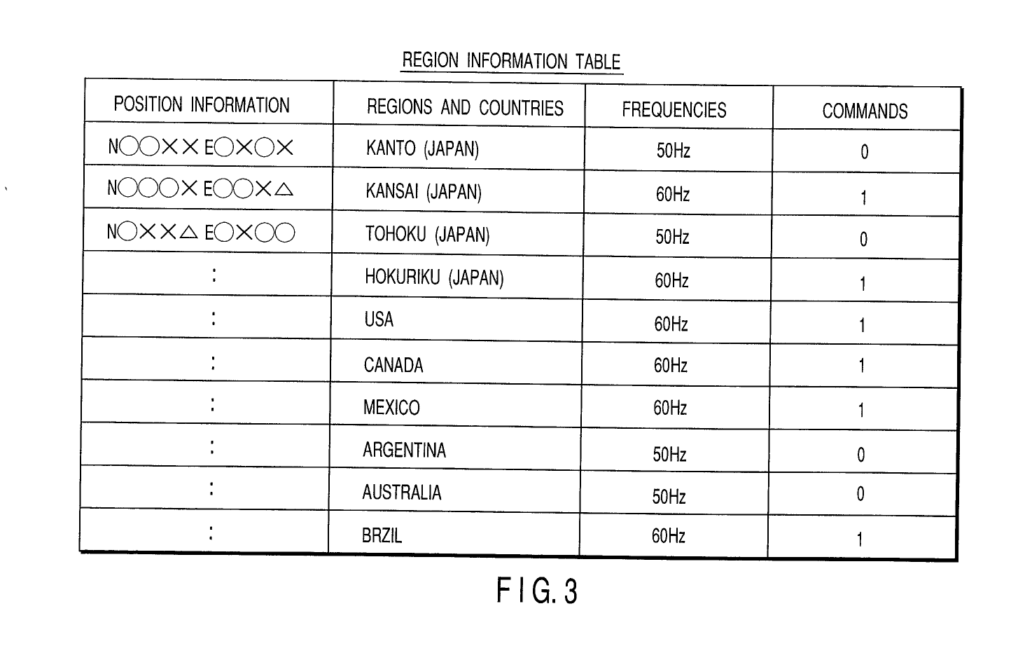

A region information table 13a is stored in the memory section 13A. The memory section 13A may have the structure shown in FIG. 3. The table 13a stores position information representing the latitude and longitude, the regions including positions represented by the position information, the commercial power frequencies used in the regions, and the commands set in correspondence with the commercial power frequencies. The region information represents the names of countries or the names of regions if it concerns with the domestic regions.

The control section 12A comprises hardware items, such as a microprocessor (MPU), a program memory for storing various control programs, and a data memory for temporarily storing the transmission and reception data and the control data. The control section 12A comprises software items, as well, such as a program for controlling the speech communication and the data communication, a control program for recording and reproducing the communication speech data by using the memory section 13A, and the like. The control section 12A also comprises control programs for implementing control functions, including a position detecting function 12a and a display drive frequency controlling function 12b.

The program implementing the position detecting function 12a, in a standby state, receives broadcast information signals that a plurality of peripheral base stations have transmitted over paging channels. The he program then extracts the position information about each the peripheral base station, from a system parameter message included in the received information signal. The program estimates the position of the apparatus on the basis of the position information extracted.

The program implementing the display drive frequency controlling function 12b accesses the region information table 13a stored in the memory section 13A, on the basis of the position information relating to the apparatus estimated by the position detecting function 12a. Then, the program reads the set command corresponding to the commercial power frequency used in the region where the terminal is located. The set command is supplied to the display timing generation circuit 213 of the display drive circuit 21.

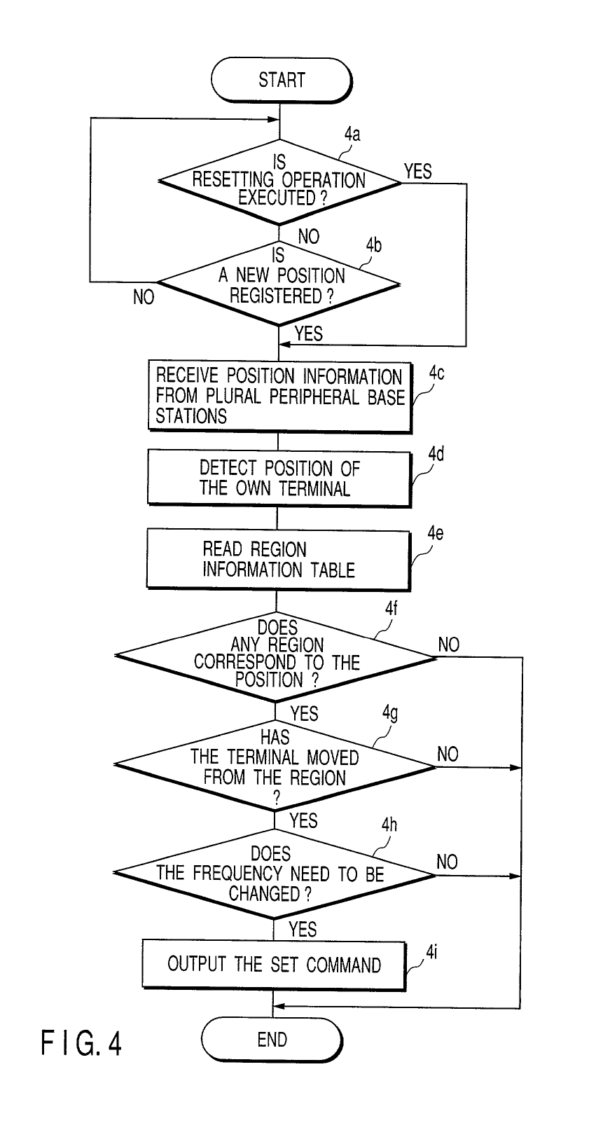

The operation of the above-constituted mobile communication terminal will be explained. FIG. 4 is a flowchart illustrating the procedures of controlling the position detecting function 12a and display drive frequency controlling function 12b in the control section 12A. FIG. 4 shows the contents of the control procedures, too.

The control section 12A repeatedly monitors the resetting operation executed by a user of the terminal at step 4a, to determine whether or not a new position is registered at step 4b. For example, the user of the terminal may reset the display clock frequency in the input section 14, to reduce the flicker on the display of the LCD panel 20 in this state. Alternatively, the power of the terminal may be supplied or the procedures of the position registration may be executed with the base station in accordance with the movement of the terminal. In either case, the control section 12A executes the following control at step 4c, to receive the position information from one of a plurality of peripheral base stations.

The CDMA base stations transmit signals on a pilot channel, a sync channel and a paging channel. The terminal identifies the base stations from the signals it receives on these channels. Then, the terminal selects the CDMA base station that is in the best condition, from the plurality of CDMA base stations. The terminal therefore establishes synchronization with the base station, and goes into a standby state. In the standby state, the terminal performs intermittent reception.

The CDMA base station transmits the broadcasting information on the paging channel. A system parameter message is inserted in the broadcasting information. The system parameter message includes the position information of the base station. The position information represents the latitude and the longitude. The CDMA base station also transmits an extended neighbor list message, which is contained in the broadcasting information.

When the mobile communication terminal first receives the broadcasting information from the synchronized CDMA base station, the mobile communication terminal extracts the system parameter message from the broadcasting information and extracts the position information of the base station from the system parameter message. At the same time, the terminal extracts the extended neighbor list message from the broadcasting information and acquires the information about a plurality of peripheral base stations from the extended neighbor list message. On the basis of the information, the terminal identifies the peripheral CDMA base stations, one after another. The terminal receives the broadcasting information of each base station identified, and extracts the position information about the base station from the broadcasting information.

When the mobile communication terminal acquires the position information concerning the synchronized base station and the peripheral base stations, the control section 12A incorporated in the terminal calculates, at step 4d, the position of the terminal from the position information and the reception-field intensity of each base station.

When the control section 12A detects the position of the terminal, the control section 12A reads the region information table 13a from the memory section 13A, at step 4e. On the basis of the position of the terminal and the region information table 13a, the control section 12A determines, at step 4f, whether a region corresponding to the position of the terminal exists or not. If the section 12A determines that such a region exists, it then determines, at step 4g, whether or not the terminal has moved from the region where the terminal is located. If the terminal has moved, the control section 12A determines at step 4h whether or not the commercial power frequency has changed, from the previously recognized frequency. If the section 12A detects the change of the commercial power frequency, it determines that the display clock frequency of the display drive circuit 21 needs to be changed. The operation shifts to step 4i. In step 4i, the control section 12A reads the corresponding set command from the region information table 13a and supplies the set command to the display drive circuit 21.

Thus, in the display drive circuit 21, the DUTY value of the display timing generation circuit 213 is varied in response to the set command. The display clock frequency is therefore variable. Accordingly, the flicker is not noticeable on the LCD panel 20, with the commercial power frequency used in the region.

The display clock frequency generated from the display timing generation circuit 213 is set in the following manner.

The display timing generation circuit 213 divides the reference oscillation frequency fosc generated by a reference oscillator (not shown) by n, generating a frame frequency for an LCD display. The display frame frequency is represented by (fcl*DUTY value), where fcl is the display clock frequency. Thus, the display frame frequency can be changed to any desired value by varying the DUTY value of the display clock frequency fcl.

A case, where the reference oscillation frequency fosc is 33 KHz and the ratio of the frequency division n is 8 (that is, the display clock frequency fcl is 4125 Hz), will be described below.

It is visually confirmed that flicker occurs on the display of the LCD under a fluorescent lamp, as will be described below.

If the commercial power frequency is 50 Hz, the flicker is noticeable when the display frame frequency is 78 Hz or higher, but lower than 100 Hz, and the flicker is not noticeable, if the display frame frequency is 64 Hz or higher, but lower than 78 Hz.

If the commercial power frequency is 60 Hz, the flicker is not noticeable when the display frame frequency is 72 Hz or higher, but lower than 98 Hz, and the flicker is noticeable when the display frame frequency is 60 Hz or higher, but lower than 72 Hz.

Hence, to make the flicker not noticeable on the display of the LCD with the commercial power frequencies at both 50 Hz and 60 Hz, it is necessary to generate a display frame frequency ranging 72 Hz to 78 Hz. A display frame frequency falling in this range is equivalent to the DUTY value ranging from 1/53 to 1/57.

However, the reference oscillation frequency fosc of the reference oscillator changes with operating conditions such as temperature. The display frame frequency does not always fall within the above-mentioned optimum range, even if the DUTY value is set in the above range.

In view of this, different DUTY values are set respectively when the commercial power frequency is 50 Hz or 60 Hz in this embodiment. The DUTY value is selected in accordance with the commercial power frequency.

For example, the DUTY value ranges from 1/53 to 1/64 when the commercial power frequency is 50 Hz, and from 1/43 to 1/57 when the commercial power frequency is 60 Hz. Further, the DUTY values of 1/58 and 1/50, both close to the intermediate values of these ranges, are set.

The display timing generation circuit 213 has a switch circuit for selecting one of the two DUTY values. The switch circuit operates in response to the set command supplied from the control section 12A, selecting and outputting one of the two DUTY values. For example, the switch circuit outputs the DUTY value 1/58 when the set command is “0”. When the set command is “1”, the switch circuit outputs the DUTY value 1/50.

As described above, the display timing generation circuit 213 comprises the circuit for selecting one of the two DUTY values. The memory section 13A has the region information table 13a that shows the regions corresponding to the position information of the terminal, the commercial power frequencies used in the stored regions and the commands that are set to correspond to the commercial power frequencies. The position information is acquired from a plurality of peripheral base stations. The position of the terminal is calculated on the basis of the acquired information, when the terminal user performs a reset operation or the position registration procedure. The set command is read from the region information table 13a on the basis of the calculated position and supplied to the display timing generation circuit 213. This makes it possible to select one of the two DUTY values.

Therefore, the LCD display device 15 can generate the display frame frequency that does not interfere with the commercial power frequency used in the region where the terminal is present. Even if the mobile communication terminal is used in any country and any region, the interference with the indoor fluorescent lamp can be prevented and thereby high-quality LCD display can be always implemented.

In addition, two optimum DUTY values are preset respectively for two commercial power frequencies (50 Hz and 60 Hz). One of the DUTY values is designated by the set command supplied from the control section 12A. Therefore, the optimum display frame frequency corresponding to the commercial power frequency can be always generated. Thus, the variation of the reference oscillation frequencies, due to the temperature of the reference oscillation or the influence of the control error, can be reduced. A highly reliable display frame frequency can be always generated.

The position of the terminal is detected by using the position informing function provided in the mobile communication system. Additionally, commercial power frequency is determined from both the detected position information and the pre-stored region information table 13a. It is therefore unnecessary to provide a new position detecting function (e.g., a GPS receiver or the like) in the mobile communication terminal. Thus, a simple structure that can be manufactured at low cost can detect the commercial power frequency for each region.

(Second Embodiment)

A mobile communication terminal according to the second embodiment of the invention detects the base station position information transmitted from the base station in established synchronization (i.e. the base station connected to the terminal), as the position information of the terminal. The mobile communication terminal reads the set command from the region information table, in accordance with the position information. In response to the set command the terminal controls the display drive signal frequency generated by the display timing generation circuit.

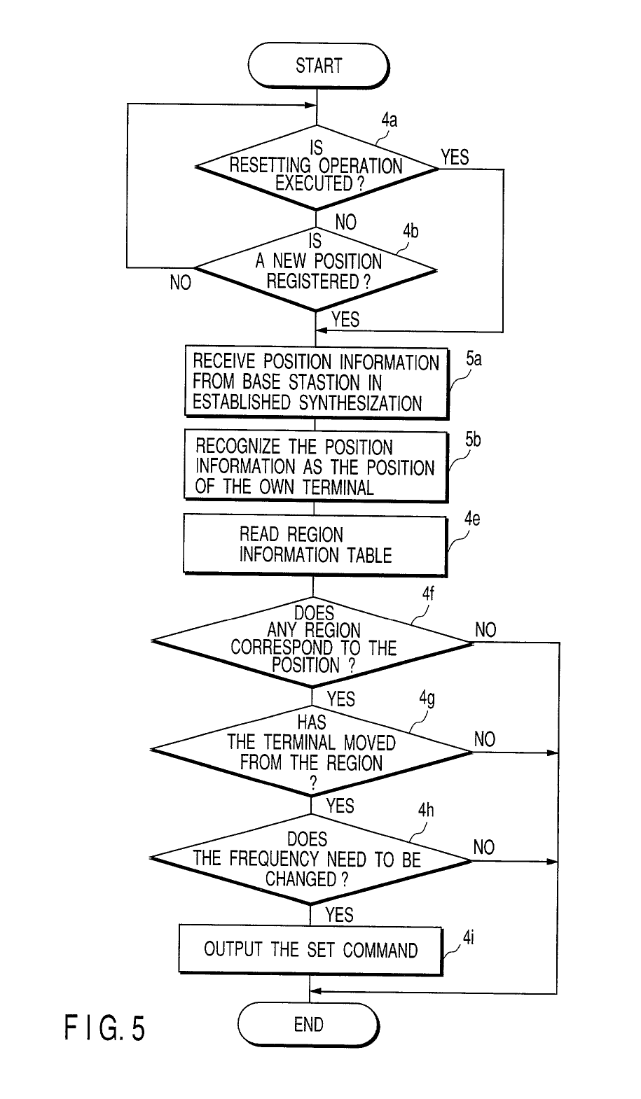

FIG. 5 is a flowchart explaining the procedures of controlling the display drive frequency in the mobile communication terminal according to the second embodiment. The same portions as those of FIG. 4 are denoted at the same reference numerals and will not be described in detail.

When the terminal user resets the display clock frequency, when power is supplied to the terminal, or when the position is moved and its new position is registered in the base station, the control section 12A of the terminal shifts to step 5a. In step 5a, the control section 12A receives the broadcasting information from the synchronized base station. The section 12A extracts the position information of the synchronized base station from the system parameter message contained in the broadcasting information. At step 5b, the section 12A detects the position information as the information representing the current position of the terminal.

After acquiring the position information of the terminal, the control section 12A reads the region information table 13a from the memory section 13A at step 4e. Then, at step 4f, the section 12A detects the presence of the region corresponding to the position information on the basis of the position of the terminal and the region information table 13a. If the section 12A determines that the corresponding region exists, it then determines at step 4g whether or not the terminal has moved from the region previously detected. If the terminal has moved so, the section 12A determines at step 4h whether the commercial power frequency has changed or not. If it is determined that the commercial power frequency has changed, the control section 12A determines that the display clock frequency of the display drive circuit 21 needs to be shifted. The operation shifts to step 4i, at which the control section 12A reads the corresponding set command from the region information table 13a and supplies the set command to the display drive circuit 21.

As described above, the position information of the base station can be used as the position information of the terminal in the second embodiment of the invention. Hence, the position of the terminal need not be calculated. This decreases the load on the control section 12A. The second embodiment can be applied to the general mobile telephone system, too. Nonetheless, the second embodiment is particularly effective if applied to a micro-cell mobile communication system in which a cell (a radio communication area) formed by the base station is comparatively small. This is because the error can be small in the detection of the terminal position.

(Third Embodiment)

In the mobile communication terminal according to the third embodiment of the invention, a charger for charging the battery of the mobile communication terminal can detect the commercial power frequency, and a power information table is provided in the memory section of the mobile communication terminal. The power information table stores a command for setting the commercial power frequency and a display clock frequency applicable to the commercial power frequency. Whenever read from the power information table, the set command corresponding to the detected commercial power frequency sets the display clock frequency generated by the display timing generation circuit.

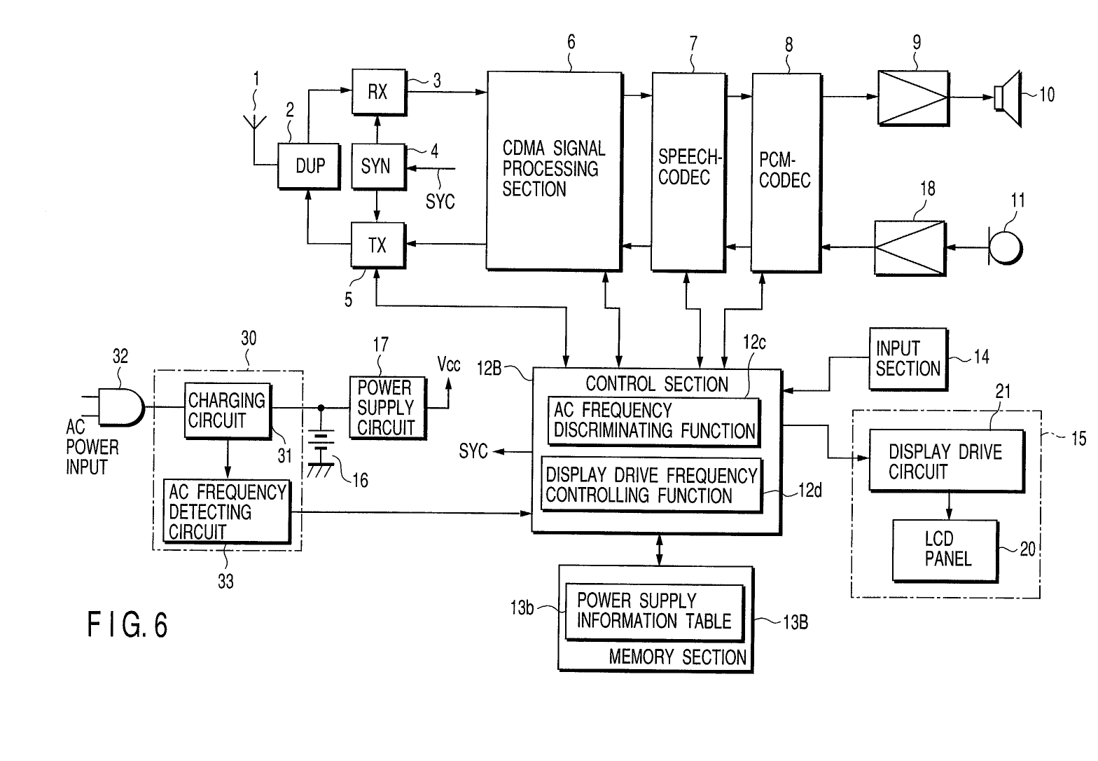

FIG. 6 is a block diagram of the mobile communication terminal according to the third embodiment. The same components as those shown in FIG. 1 are denoted at the same reference numerals and will not be described in detail.

A charger 30 may be connected to the mobile communication terminal. The charger 30 comprises a charging circuit 31 and a commercial power frequency (AC frequency called hereafter) detection circuit 33. The charging circuit 31 generates a charging voltage from the commercial power voltage supplied through an AC power input 32 and supplies the charging voltage to the battery 16. The mobile communication terminal is connected to the charging output terminal of the charging circuit 31.

The AC frequency detection circuit 33 detects the frequency from the commercial power output supplied through the AC power input 32. The data representing the detected frequency detected is supplied to a control section 12B.

A power supply information table 13b is provided in the memory section 13B of the mobile communication terminal. The memory section 13B stores the commercial power frequency and a set command for setting the display clock frequency applicable to the commercial power frequency. The commercial power frequency and the set command correspond to each other.

The control section 12B includes an AC frequency determining function 12c and a display drive frequency controlling function 12d. The functions 12c and 12d are control functions in the present invention.

The AC frequency determining function 12c determines whether the commercial power frequency in use is 50 Hz or 60 Hz, from the frequency supplied from the AC frequency detection circuit 33 of the charger 30.

The display drive frequency controlling function 12d achieves an access to the power supply information table 13b, in accordance with the result of determination of the AC frequency determining function 12c. The function 12d reads the set command there from and supplies the same to the display timing generation circuit 213 provided in the display drive circuit 21.

When the user connects the mobile communication terminal to the charging terminal of the charger 30 so as to charge the battery of the mobile communication terminal, the charging circuit 31 starts charging the battery 16. Prior to the charging, the control section 12B and the display section 15 have been operating for a certain period and the setting of the display drive frequency has been controlled.

The control section 12B receives the commercial power frequency detected, from the AC frequency detection circuit 33. The section 12B determines whether the commercial power frequency is 50 Hz or 60 Hz, on the basis of this detected frequency. From the result of the determination, the section 12B determines whether or not the commercial power frequency has varied from the value previously detected. If it is determined that the commercial power frequency has varied, the section 12B determines that the display clock frequency of the display drive circuit 21 needs to be changed. Then, the control section 12B reads a set command from the region information table 13a and supplies the set command to the display timing generation circuit 213 provided in the display drive circuit 21.

In the display drive circuit 21, the DUTY value of the display timing generation circuit 213 therefore changes in accordance with the set command. The display clock frequency is thereby changed. As a result, the flicker becomes unnoticeable on the display of the LCD panel 20, even under the commercial power frequency used in the region.

As described above, the commercial power frequency used at the current position is directly detected in the third embodiment. In accordance with the detected commercial power frequency, a preset command is read from the power supply information table 13b. The set command is supplied to the display timing generation circuit, whereby the display drive frequency is set at a value applicable to the commercial power frequency.

Therefore, the LCD display device 15 can generate a display frame frequency that does not interfere with the commercial power frequency used in the region where the terminal exists. Interference with the indoor fluorescent lamp is avoided even if the mobile communication terminal is used in any country or region. High-quality LCD display can be implemented always.

Moreover, in the third embodiment, the AC frequency detection circuit 33 is provided in the charger 30 so as to detect the commercial power frequency. Therefore, another AC frequency detection circuit does not need to be provided in the mobile communication terminal, and it is thereby possible to prevent the configuration of the mobile communication terminal from becoming large. Since the setting of the display drive frequency is automatically controlled in the charging process, no burden is applied on the user.

(Other Embodiments)

In the first and second embodiments, the position information of the mobile communication terminal is acquired on the basis of the base station position information that the base station broadcasts. Instead, the position the terminal takes at present may be measured by using the GPS (Global Positioning System).

In this case, the mobile communication terminal incorporates a GPS receiver. If the terminal incorporates, for example, a navigation type GPS receiver, too, the position of the terminal may be acquired by inputting the reception data from the external GPS receiver. Alternatively, the position data derived from the external GPS receiver may be input and used without being modified at all.

The second embodiment receives the position information (i.e. the latitude and the longitude) from the base station and uses the information as one representing the position of the terminal. Nevertheless, the region where the terminal exists may be determined from the system identification information (SID) or base station identification information (BS-ID) included in the broadcasting information transmitted from the base station. If this is the case, a table showing the relationship between the region information and the SID or BS-ID only needs to be stored in the memory section 13A.

Further, the region does not need to be identified. The table representing the relationship between the region information and the SID or BS-ID may be preliminarily stored in the memory section 13B. Then, the corresponding set command may be read from the table on the basis of the SID or BS-ID and supplied to the display timing generation circuit, after the SID or BS-ID is extracted from the broadcasting information transmitted from the base station.

In the first and second embodiments, the region where the terminal exists is identified by detecting the position information of the terminal. Instead, the user may operates the input section 14, inputting the data about the region where the terminal currently exists, such as the name of the country, or the name of the prefecture or city, town or village if the region is domestic. In this case, a list of the names of the regions to be input should be preliminarily stored in the memory section 13A and the region should be designated on the basis of this list.

When the user performs an input operation, the list of the regions stored in the memory section 13A is read and displayed on the display section 15. The user may input the name of the region by selecting the region corresponding to the current position, from the list of the regions.

To detect the commercial power frequency used in the region, an optical sensor may be provided at the terminal, for detecting the frequency causing the flicker of the fluorescent lamp.

The region information table 13a need not store overall information about all the regions. For example, the region information about one region may be loaded to the terminal from the communication network or from the base station. This helps to save the storage capacity of the mobile communication terminal.

The embodiments described above are CDMA mobile communication terminals. Nonetheless, the present invention can be applied to TDMA mobile communication terminals, notebook-sized personal computers, PDAs and other mobile communication terminals. In addition, the invention can be applied to portable audio instruments, TV receivers and other electronic devices.

The structure of the means for determining the commercial power supply voltage, the structure of the means for setting the display drive signal at various frequencies, the configuration of the liquid crystal device, and the like can be changed and modified in various ways, without departing from the scope and spirit of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display device for synchronizing display data to a display drive signal, supplying the display data to a liquid crystal display unit and allowing the liquid crystal display unit to display the display data, said device comprising:
drive signal generation means for generating one of a plurality of display drive signals, each signal having a frequency different from that of any other;
frequency detecting means for detecting a commercial power frequency of a region where the device is used; and
control means for changing frequencies of the display drive signals generated by said drive signal generation means, in accordance with the commercial power frequency detected by the frequency detecting means.

2. A liquid crystal display device for synchronizing display data to a display drive signal, supplying the display data to a liquid crystal display unit and allowing the liquid crystal display unit to display the display data, said device comprising:
drive signal generation means for generating one of a plurality of display drive signals, each signal having a frequency different from that of any other;
information acquisition means for acquiring geometric information representing a current position of an electronic device including the LCD device; and
control means for determining a display drive signal frequency applicable to the current position of the electronic device, from the geometric information acquired by said geometric information acquisition means, and for allowing said drive signal generation means to generate the display drive signal of said frequency.

3. An electronic device comprising:
drive signal generation means for generating one of a plurality of display drive signals, each signal having a frequency different from that of any other;
drive means for synchronizing display data to the display drive signals generated by said drive signal generation means and for allowing the synchronized display data to be displayed on a liquid crystal display unit;
frequency detecting means for detecting a commercial power frequency of a region where said electric device is used; and
control means for changing frequencies of the display drive signals generated by said drive signal generation means, in accordance with the commercial power frequency detected by the frequency detecting means.

4. An electronic device according to claim 3, wherein said frequency detecting means detects a frequency from a commercial power supply output supplied from said commercial power supply terminal, when the electronic device is connected to a commercial power supply terminal; and said control means changes frequencies of the display drive signals generated by said drive signal generation means, in accordance with the commercial power frequency detected by said frequency detecting means.

5. An electronic device according to claim 4, which further comprises an internal battery and a charging circuit for charging the internal battery on the basis of the commercial power supply output supplied from said commercial power supply terminal, and in which said frequency detecting means detects the frequency from the commercial power supplied from said commercial power supply terminal while said internal battery is charged.

6. An electronic device comprising:
drive signal generation means for generating a plurality of display drive signals, each signal having a frequency different from that of any other;
drive means for synchronizing display data to the display drive signals generated by said drive signal generation means and for allowing the synchronized display data to be displayed on a liquid crystal display unit;
information acquisition means for acquiring geometric information representing a current position where the electronic device is present; and
control means for determining a display drive signal frequency applicable to the current position of the electronic device, from the geometric information acquired by said information acquisition means, and for allowing said drive signal generation means to generate the display drive signal of said frequency.

7. An electronic device according to claim 6, wherein said information acquisition means includes input means for allowing a user of the device to input the geometric information representing the current position of the electronic device.

8. An electronic device according to claim 6, wherein said information acquisition means includes data reception means for receiving data for determining the current position of the electronic device, said data having been broadcast via a satellite; and
means for generating the geometric information representing the current position of the electronic device, from the data received by said data reception means.

9. An electronic device according to claim 6, wherein said information acquisition means includes data receiving means for receiving data for measuring the current position of the electronic device, from a data receiver which is provided outside the electronic device and which receives the data transmitted from a satellite; and
means for generating the geometric information representing the current position of the electronic device, from the data inputted by said data reception means.

10. An electronic device according to claim 6, wherein said control means includes memory means for storing data representing relation between a region, where use of the electronic device is expected, and the display drive signal frequency applicable to said region; and
frequency detecting means for detecting the display drive signal frequency applicable to the current position of the electronic device, from the geometric information acquired by said information acquisition means and the stored data, and for allowing said drive signal generation means to generate the display drive signal of the frequency detected by the frequency detecting means.

11. A mobile communication terminal for communicating with a base station over a radio channel, comprising:
drive signal generation means for generating one of a plurality of display drive signals, each signal having a frequency different from that of any other;
drive means for synchronizing display data to the display drive signals generated by said drive signal generation means and for allowing the synchronized display data to be displayed on a liquid crystal display unit;
information acquisition means for acquiring geometric information representing a current position where the terminal is present; and
control means for determining a display drive signal frequency applicable to the current position of the terminal, from the geometric information acquired by said information acquisition means, and for allowing said drive signal generation means to generate the display drive signal with the frequency determined by the control means.

12. A mobile communication terminal according to claim 11, wherein said information acquisition means includes input means for allowing a user of the terminal to input the geometric information representing the current position of the terminal.

13. A mobile communication terminal according to claim 11, wherein said information acquisition means receives position information of the base station connected to the mobile terminal and uses the position information of the base station as the geometric information representing the current position of the terminal.

14. A mobile communication terminal according to claim 11, wherein said information acquisition means receives position information from a plurality of peripheral base stations and generates the geometric information representing the current position of the terminal, from the basis of the position information supplied from said plurality of peripheral base stations.

15. A mobile communication terminal according to claim 11, wherein said information acquisition means includes data reception means for receiving data for measuring the current position of the terminal, which is broadcast via a satellite; and
means for generating the geometric information representing the current position of the terminal, from the data received by said data reception means.

16. A mobile communication terminal according to claim 11, wherein said information acquisition means includes data receiving means for receiving data for measuring the current position of the device received by a positioning data receiver, which is provided outside the mobile communication terminal and which receives data that a satellite broadcasts; and
means for generating the geometric information representing the current position of the mobile communication terminal, from the data received by said data reception means.

17. A mobile communication terminal according to claim 11, wherein said control means includes first memory means for storing data representing a relation between a region where use of the terminal is expected and the display drive signal frequency applicable to said region; and
means for determining the display drive signal frequency applicable to the current position of the terminal, from the geometric information acquired by said information acquisition means and the stored data, and for allowing said drive signal generation means to generate the display drive signal of the frequency determined.

18. A mobile communication terminal according to claim 17, further comprising means for receiving, said data to be stored representing the relation between the region including the current position of the terminal and the display drive signal frequency applicable to said region, and for allowing said first memory means to store said data.

19. A mobile communication terminal according to claim 11, wherein said information acquisition means has a function of receiving base station identification information from the connected base station, and
said frequency control means includes second memory means for storing data representing a relation between base station identification information about a plurality of base stations and the display drive signal frequencies applicable to the stored base station identification information; and
means for determining the display drive signal frequency applicable to the current position of the terminal, from the base station identification information acquired by said information acquisition means and the data stored in said second memory means, and for allowing said drive signal generation means to generate the display drive signal of the frequency determined.
